(19) United States
(12) Patent Application Publication
(10) Pub. No.: US 2006/0161932 A1
(43) Pub. Date: Jul. 20, 2006

(54) Disk drive having disk carrying roller

(76) Inventor: Kazuhiro Watanabe, Fukui (JP)

Correspondence Address: WENDEROTH, LIND & PONACK, L.L.P., 2033 K STREET N. W., SUITE 800, WASHINGTON, DC, 20006-1021, US

(21) Appl. No.: 11/317,148

(22) Filed: Dec. 27, 2005

(30) Foreign Application Priority Data
Dec. 28, 2004 (JP) 2004-378534

(51) Int. Cl. G11B 17/04

(52) U.S. Cl. 720/611

(57) ABSTRACT

In a slot-in type disk drive which carries a disk with pinching by rollers provided at both sides of a disk insertion slot, the drive includes a disk drawing mechanism having at least a drive roller provided at one side of the disk insertion slot and rotated by a motor, and at least a support roller provided at the other side rotatably journalled to a fixed shaft standing from a slider provided movably in outward direction. The support roller has a shaft hole where an engaging part is formed, and the fixed shaft to be fitted into the shaft hole has a seizing part to be engaged with the engaging part of the shaft hole. When the disk is pinched between the drive roller and the support roller, the engaging part of the shaft hole is engaged with the seizing part of the shaft so that rotation is restrained.

### BACKGROUND OF THE INVENTION

1. Field of the Invention

The present invention relates to a disk drive of so-called slot-in type in which pinches and carries a disk by rollers provided at both sides of a disk insertion slot as a disk carrying unit for carrying the disk onto a turntable.

2. Related Art

As a disk drive of so-called slot-in type, for example, “Disk Loading System” disclosed in JP-A-2004-146022 (corresponding to US-A-2004/0085866) is known. The disk loading system is configured in such a way that two rollers are provided at both sides of a disk insertion slot, and an inserted disk is pinched and carried onto a turntable by the rollers. At one side, the rollers include a first drive roller provided in a fixed position at an insertion slot side, and a second drive roller mounted on a tip end of an arm swinging with an axis of the first drive roller as a center so that rollers are linked to each other. At the other side of the insertion slot, a first free roller and a second free roller are rotatably journalled to a slider that is moved outwardly, and the arm is inclined inwardly and the slider is biased with spring force to inwardly deflect the slider.

Here, the disk is rotated by the first drive roller and the second drive roller with the first and second free rollers as fulcrums so that the disk is drawn into the inside of the drive. However, when the first and second free rollers are journalled in a substantially nonrotating condition, the free rollers always contact to the periphery of the disk at a fixed position, resulting in wear of the free rollers, and particular portions of the first and second free rollers become dirty due to dirt adhered on the periphery. Therefore, the disk is slipped at portions for receiving the disk as the fulcrums of the disk, which may cause obstruction to carrying the disk into the drive.

In “Disk Loading Roll” according to JP-A-2002-313004, the disk loading roll is formed from a rubber elastic body having an outer peripheral surface whose external diameter is changed along the axis direction and loading a disk abutting against the peripheral part of the disk, the inner peripheral surface of the roll is formed in a rugged surface, so that the disk can be securely loaded and noise can be prevented.

In “Reproducing Device for Memory Plate” according to JP-A-10-302365, in order to minimize load of a memory plate during carrying, at least one free roller has a rotation axis extending approximately perpendicularly to an entering plane on which the memory plate is transferred to a reproduction position, and a narrowed area is provided in the entering plane so that when the memory plate is pressed in and/or out with respect to an insertion shaft, an edge area of the memory plate is engaged in the narrowed area approximately perpendicularly to the rotation axis, thereby the memory plate is guided through the narrowed area during carrying the memory plate. However, in either case, the same problem as in JP-A-2004-146022 occurs.

### SUMMARY OF THE INVENTION

To solve the problems in the related art, an object of the invention is to provide a disk drive having first and second free rollers rotatably journalled, which is locked to prevent rotation when the disk is pinched and carried.

Thus, a disk drive according to the invention is constituted to include a disk drawing mechanism for drawing a disk onto a turntable, the disk drawing mechanism having at least a drive roller provided at one side of a disk insertion slot and rotated by a motor, and at least a support roller provided at the other side rotatably journalled to a fixed shaft standing from a slider provided movably in outward direction, wherein the support roller has a shaft hole in which an engaging part is formed, and the fixed shaft to be fitted into the shaft hole has a seizing part to be engaged with the engaging part of the shaft hole. According to such a constitution, when the disk is pinched between the drive roller and the support roller and carried while the support roller is subjected to lateral pressure by the disk, the engaging part of the shaft hole is engaged with the seizing part of the shaft, thereby the support roller is locked and not rotated, and consequently the disk is drawn while it is rotated by the drive roller with the support roller as a fulcrum.

The drive roller is preferably constituted with a first drive roller rotated by the motor and a second drive roller provided at a tip end of an arm swinging with an axis of the first drive roller as a center and linked to the first drive roller, and the support roller is constituted with a first support roller and a second support roller rotatably journalled to both ends of the slider respectively, and the arm can be inclined inwardly and the slider is biased inwardly.

The shaft hole of the support roller may be formed to have a regular hexagonal section, and a flat face to be seized with one side of the regular hexagonal of the shaft hole is formed on the periphery of the shaft. Moreover, it is acceptable that the shaft hole of the support roller is formed to have an approximately regular tetragon section having rounded corners, and the periphery of the shaft is formed to have an approximately regular tetragon section having rounded corners, which is to be seized with one side of the regular tetragon of the shaft hole. Furthermore, it is acceptable that the shaft hole of the support roller is formed to have a circular section and a slit groove is formed on an inner circumferential face in an axial direction, and a protrusion to be fitted in the slit groove and extends in an axial direction is formed on the periphery of the shaft.

According to the disk drive of the invention, when the disk is first pushed into the disk insertion slot, the support rollers forming the drawing mechanism is rotated so that the disk can be advanced smoothly; and when the disk is pinched between the support rollers and the drive rollers and thereby lateral pressure to the support rollers is increased, the support rollers are locked to prevent rotation. Consequently, one side of the periphery of the disk is contacted to the support rollers and supported non-rotatably by the roller, and the other side is rotated along with rotation of the drive rollers and drawn in.

Since the support rollers are rotatable except for a period during carrying the disk, points of the support rollers to be contacted to the periphery of the disk are changed. Therefore, dirt adhered on the periphery of the disk is not accumulated on a particular point of the support roller, and consequently a situation that the disk pinched and supported by the support rollers is slipped can be prevented. Moreover, wear of a particular point of the support roller can be avoided.

### BRIEF DESCRIPTION OF THE DRAWING

FIG. 1 is a perspective view showing a disk drive according to an embodiment of the invention;

FIG. 2 is a plan view showing the inside of the disk drive;

FIG. 3 is a front view showing the inside of the disk drive;

FIG. 4 is a plan view showing a disk drawing mechanism of the disk drive;

FIG. 5 is a plan view showing a process of disk drawing by the disk drawing mechanism;

FIG. 6 is a plan view showing a condition that a disk is drawn to neighborhood of a turnable;

FIG. 7 is horizontal section views showing a support structure of a first support roller in the disk drive;

FIG. 8 is horizontal section views showing another embodiment of the support structure of the first support roller; and

FIG. 9 is horizontal section views showing still another embodiment of the support structure of the first support roller.

### DETAILED DESCRIPTION OF PREFERRED EMBODIMENT

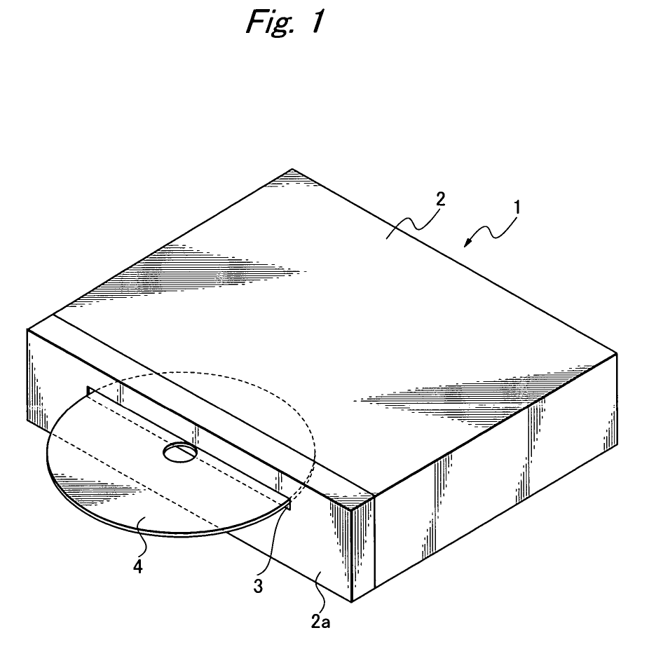

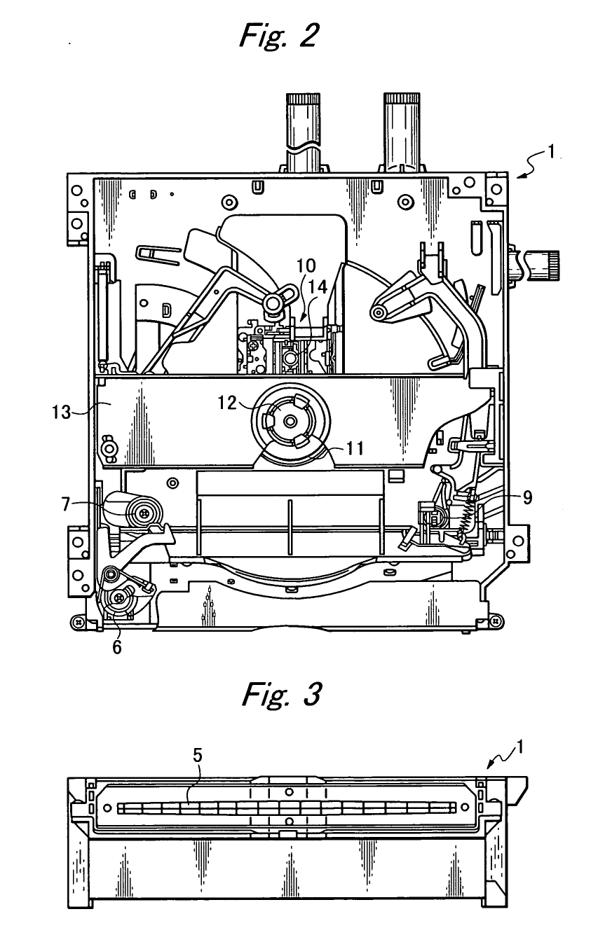

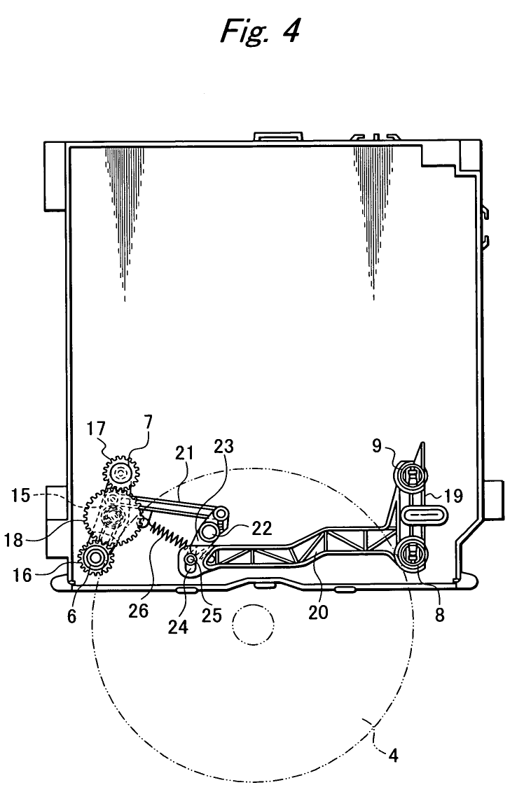

Figures show a disk drive 1 according to an embodiment of the invention, which has a structure where a disk 4 is freely carried in and out through a slit-like disk-insertion-slot 3 provided in a front panel 2a of a cabinet 2 (refer to FIG. 1). At a backside of the disk insertion slot 3 within the cabinet 2, the disk drive 1 has felt 5 for removing dust or dirt adhered on a surface of the disk when the disk 4 to be inserted is passed therethrough (refer to FIG. 3). A first drive roller 6 and a second drive roller 7 are provided at the left of an entrance (front side), and a first support roller 8 and a second support roller 9 are provided at the right of the entrance (refer to FIG. 2 and FIG. 4).

As shown in FIG. 2, a turntable 11 for setting the disk 4 is disposed at the center of the disk drive 1 in a manner of being mounted on a traverse unit 10, and a damper 12 for pinching and damping the disk 4 against the turntable 11 is provided at the center of a connecting top plate 13. Moreover, the traverse unit 10 has an optical pickup unit 14 for reading data recorded in the disk 4 rotating on the turntable 11, and conversely for recording data.

As shown in FIG. 4, a disk drawing mechanism of the disk drive 1 is constituted with the first drive roller 6 and the second drive roller 7 mounted at a tip end of an arm 15 swinging with a shaft of the first drive roller 6 as a center, which are disposed at the left of the entrance, and the first support roller 8 and the second support roller 9 disposed at the right of the entrance. The first drive roller 6 is mounted coaxially with a first gear 16, and the second drive roller 7 is also mounted coaxially with a second gear 17.

The mechanism is constituted in which the arm 15 is mounted with an intermediate gear 18 lying between the first gear 16 and the second gear 17 and engaging with each of the first and second gears 16, 17, and when the first drive roller 6 is rotationally driven by a certain motor (not shown), the second drive roller 7 is rotated via the first gear 16, the intermediate gear 18 and the second gear 17. Since the second drive roller 7 is mounted on the tip end of the swinging arm 15, a position of the roller is changed according to motion of the disk 4 inserted from the disk insertion slot 3. That is, the arm 15 swings while it keeps a contact condition of the second drive roller 7 to the periphery of the disk 4.

The first and second support rollers 8 and 9 disposed at the right of the entrance are rotatably journalled on a slider 19 which is set outward movably along a guide groove (not shown). Therefore, when the disk 4 inserted from the disk insertion slot 3 through the felt 5 is contacted to the first support roller 8 or the second support roller 9, the slider 19 moves outward according to motion of the disk 4.

The slider 19 is integrally attached with a right link 20 extending to a center side, while the arm 15 is fitted pivotally with a left link 21. Respective tip ends of those left and right links 21, 20 are fitted pivotally to either end of an intermediate link 23 which is mounted rotatably with a pivot 22 standing on a chassis as a center. An elliptical hole 24 is formed at an end of the right link 20, which allows a connect pin 25 jutting from one end of the intermediate link 23 to be freely fitted therein. The left and right links 21, 20 are connected by a coil spring 26 to each other, and biased inward. The biasing member does not necessarily connect between the left and right links 21, 20, and may bias only the slider 19. Alternatively, a coil spring that biases the intermediate link 23 to rotate in a clockwise direction may be attached to the pivot 22 of the intermediate link 23.

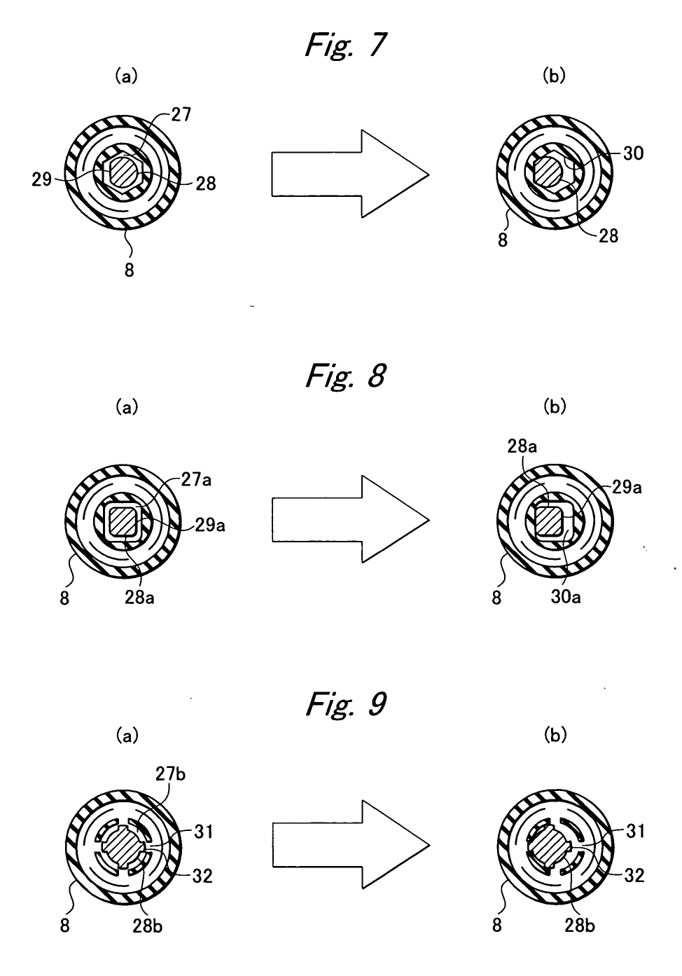

As shown in FIG. 7, the first support roller 8 has a shaft hole 27 in the center, and a shaft 28 is fitted in the shaft hole 27. The shaft hole 27 is formed to have a regular hexagonal section, and part of the shaft 28 is cut out to form a flat face 29. The first support roller 8 journalled to the shaft 28 standing fixedly on the slider 19 can be freely rotated in a condition (a) where it is not subjected to lateral pressure. However, in a condition where the disk 4 is pinched by the first support roller 8 and the first drive roller 6, the first support roller 8 is pushed outward (right) by a peripheral edge of the disk 4, and a condition (b) where the flat face 29 of the shaft 28 is engaged with an inner face 30 of the shaft hole 27 having the regular hexagonal section is formed. Therefore, the first support roller 8 is locked rather than rotated, and supports the disk 4 at a fixed position with a point on the disk 4 as a fulcrum, consequently the disk 4 is rotated with the fulcrum as a center by rotation of the first drive roller 6 and drawn in.

FIG. 8 shows another embodiment of a support structure of the first support roller 8, wherein a shaft hole 27a of the first support roller 8 is formed to have an approximately regular tetragon section having rounded corners, and a shaft 28a is also formed to have an approximately regular tetragon section having rounded corners. Even if the shaft hole 27a and the shaft 28a have the approximately regular tetragon sections in this way, the first support roller 8 can be freely rotated in a condition (a) where it is not subjected to lateral pressure. However, in a condition that the disk 4 is pinched by the first support roller 8 and the first drive roller 6, the first support roller 8 is pushed outward (right) by the peripheral edge of the disk 4, and a condition (b) where an inner face 30a of the shaft hole 27a is engaged with the flat face 29a of the shaft 28a is formed. Therefore, the first support roller 8 is locked rather than rotated.

FIG. 9 shows still another embodiment of the support structure of the first support roller 8, wherein a shaft hole 27b of the first support roller 8 is formed to have slit grooves 31, 31 . . . in an axial direction at four circular points, and protrusions 32, 32 . . . extending in an axial direction are formed on the outside of a cylindrical shaft 28b. An inner diameter of the shaft hole 27b is formed larger than an outer diameter of the protrusion 32, and the first support roller 8 can be freely rotated in a condition (a) where it is not subjected to lateral pressure. However, in a condition where the disk 4 is pinched by the first support roller 8 and the first drive roller 6, the first support roller 8 is pushed outward (right) by the peripheral edge of the disk 4, and the protrusion 32 protruding from the shaft 28b is fitted in the slit groove 31 formed in the shaft hole 27b. Therefore, the first support roller 8 is locked rather than rotated.

In this way, when the disk 4 is pinched by the first support roller 8 and the first drive roller 6, an engaging part formed in the shaft hole of the first support roller 8 is engaged with an engaging part provided on the shaft, thereby rotation is prevented. In the case of the second support roller 9, similar configuration can be made. Such a first support roller 8 is rotatable in a condition where it is not subject to strong lateral pressure, and when the disk 4 is inserted from the disk insertion slot 3, it can be slightly rotated.

According to the disk drawing mechanism constituted as above, when the disk 4 is inserted from the disk insertion slot 3, as shown in FIG. 4, the periphery of the disk 4 is first contacted to the first drive roller 6 and the first support roller 8. Then, insertion of the disk 4 is detected by a sensor, and the first drive roller 6 is rotated by a motor. A direction of the rotation is a direction that the disk 4 is drawn to the inside, that is, a counterclockwise direction; and when the disk 4 is further pressed from a near side, it is drawn into the inside. Here, since the first support roller 8 is only lightly pressed by the disk 4 at the beginning of disk insertion, it advances the disk to the inside while keeping rotation without engagement of the flat face of the shaft with the inner surface of the shaft hole.

As the disk 4 is advanced, the first support roller 8 is moved outward with the slider 19, and a distance between the first drive roller 6 and the first support roller 8 is increased. Here, the first support roller 8 is inwardly biased by the coil spring 26 such that it is always contacted to the periphery of the disk. When pressure from the peripheral edge of the disk 4 to the first support roller 8 is gradually increased and the flat face 29 or 29a of the shaft or the protrusion 32 on the shaft is engaged with the inner face 30 or 30a of the shaft hole or the slit groove 31 on the shaft hole, the first support roller is locked and not rotated, and the disk 4 is drawn into the inside of the drive while being rotated by the counterclockwise rotation of the first drive roller 6 with part of right periphery of the disk 4 as a fulcrum.

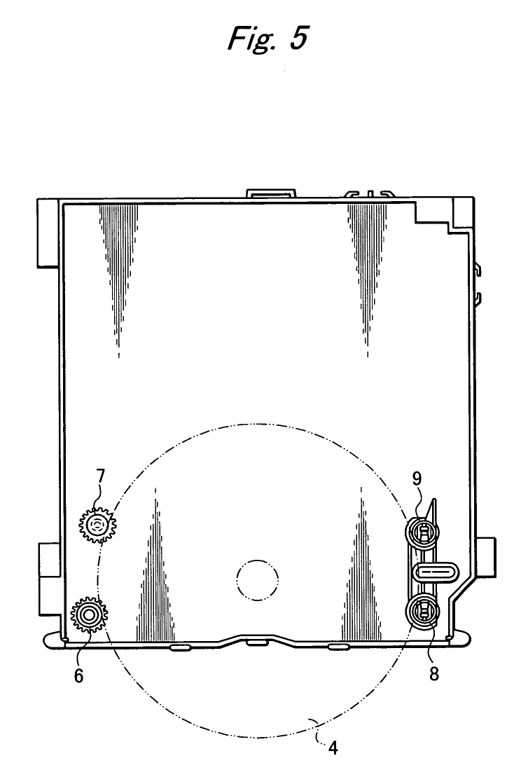

When the disk 4 is further advanced to the back, as shown in FIG. 5, the periphery of the disk 4 is further contacted to the second drive roller 7 at the left and the second support roller 9 at the right. That is, the disk 4 is pinched by four rollers of the first and second drive rollers 6, 7 and the first and second support rollers 8, 9, and the disk 4 is rotationally driven by both of the first and second drive rollers 6, 7 and thus further carried into the back. Here, when a support structure of the second support roller 9 is made to be the same as that of the first support roller 8, at the beginning of contact of the disk 4 to the second support roller 9, pressure is weak and the disk 4 is moved while the second support roller 9 is rotated. When the disk 4 is further moved, pressure of the periphery of the disk 4 becomes stronger against the second support roller 9 than against the first support roller 8, therefore the second support roller 9 is locked and not rotated, and consequently part of right periphery of the disk 4 is supported by the second support roller 9, and the disk 4 is further drawn into the inside of the drive while being rotated by counterclockwise rotation of the first drive roller 6 and the second drive roller 7.

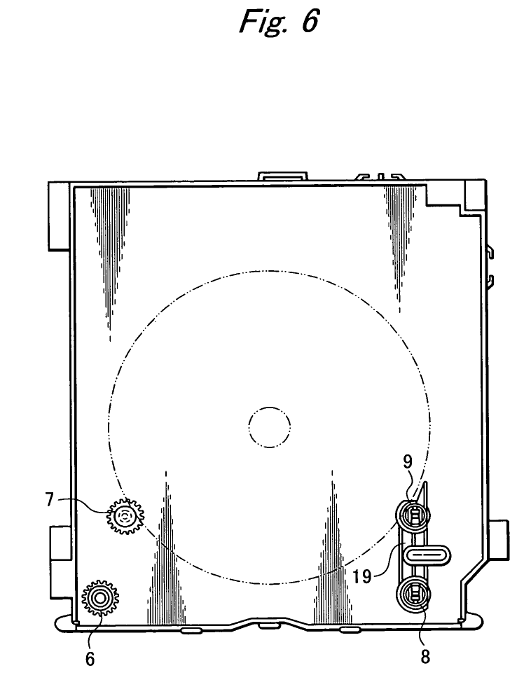

When the disk 4 is further drawn, as shown in FIG. 6, the disk 4 is separated from the first drive roller 6 and the first support roller 8, and pushed to neighborhood of the turntable by the second drive roller 7 and the second support roller 9. Then, when it is loaded on the turntable, the left and right links 21, 20 connecting between the arm 15 and the slider 19 are operated to move the disk from a position as shown in FIG. 6 to the back, and then rotate the intermediate link 23 in the counterclockwise direction so that the second drive roller 7 and the second support roller 9 are separated from the disk 4.

What is claimed is:

1. A disk drive comprising a disk drawing mechanism for drawing a disk onto a turntable, the disk drawing mechanism having at least a drive roller provided at one side of a disk insertion slot and rotated by a motor, and at least a support roller provided at the other side rotatably journalled to a fixed shaft standing from a slider provided movably in outward direction, wherein the support roller has a shaft hole in which an engaging part is formed, and the fixed shaft to be fitted into the shaft hole has a seizing part to be engaged with the engaging part of the shaft hole, whereby the engaging part of the shaft hole is engaged with the seizing part of the shaft so that rotation is restrained when the disk is pinched between the drive roller and the support roller and carried.

2. A disk drive according to claim 1, wherein the drive roller is constituted with a first drive roller rotated by the motor and a second drive roller provided at a tip end of an arm swinging with an axis of the first drive roller as a center and linked to the first drive roller, and the support roller is constituted with a first support roller and a second support roller rotatably journalled to both ends of the slider respectively, and the arm can be inclined inwardly and the slider is biased inwardly.

3. A disk drive according to claim 1, wherein the shaft hole of the support roller is formed to have a regular hexagonal section, and a flat face to be seized with one side of the regular hexagonal of the shaft hole is formed on the periphery of the shaft.

4. A disk drive according to claim 1, wherein the shaft hole of the support roller is formed to have an approximately regular tetragon section having rounded corners, and the periphery of the shaft is formed to have an approximately regular tetragon section having rounded corners, which is to be seized with one side of the regular tetragon of the shaft hole.

5. A disk drive according to claim 1, wherein the shaft hole of the support roller is formed to have a circular section and a slit groove is formed on an inner circumferential face in an axial direction, and a protrusion to be fitted in the slit groove and extends in an axial direction is formed on the periphery of the shaft.
